(19) United States
(12) Patent Application Publication
(10) Pub. No.: US 2025/0206873 A1
(43) Pub. Date: Jun. 26, 2025

(54) FLAME RETARDANT THERMOPLASTIC POLYURETHANE (TPU) BASED ON POLY-PROPANE DIOL

(71) Applicant: BASF SE, Ludwigshafen Am Rhein (DE)

(72) Inventor: Oliver Steffen Henze, Lemfoerde (DE)

(73) Assignee: BASF SE, Ludwigshafen Am Rhein (DE)

(21) Appl. No.: 18/849,004

(22) PCT Filed: Mar. 27, 2023
(86) PCT No.: PCT/EP2023/057841

§ 371 Date: Sep. 20, 2024

(30) Foreign Application Priority Data
Mar. 29, 2022 (EP) 22165100.3
May 16, 2022 (EP) 22173515.2
Jun. 24, 2022 (EP) 22180876.9

(51) Int. Cl. C08G 18/48; C08G 18/32; C08G 18/66; C08K 3/22; C08K 3/34; C08K 5/3492; C08K 5/52; C08K 5/521; C08K 5/5313; C08K 9/06; C08L 75/08

(52) U.S. Cl. CPC C08G 18/4825; C08G 18/3206; C08G 18/6674; C08K 3/346; C08K 5/34928; C08K 5/5205; C08K 5/521; C08K 5/5313; C08K 9/06; C08L 75/08; C08K 2003/2227; C08L 2201/02; C08L 2203/202

(57) ABSTRACT

A composition includes a thermoplastic polyurethane, which is the reaction product of at least the building components of diisocyanate, poly-propane diol, and chain extender. The composition also includes a flame retardant, and the flame retardant includes phosphorus. A cable can be produced with the thermoplastic polyurethane containing composition.

### BACKGROUND OF THE INVENTION

### Field of the Invention

The current invention is directed to a flame retardant thermoplastic polyurethane based on poly-propane diol.

### Description of Related Art

Flame retardant thermoplastic polyurethanes are known and described in various disclosures, see e.g. EP0617079B2, WO 2020/002200, EP00401675.

Whereas it is an ongoing demand in industry to improve the flame retardancy and at the same time keeping the chemical properties such as aging resistance and hydrolysis resistance and mechanical properties of the thermoplastic polyurethane on a high level.

For the flame retardancy various standard measurement methods are establishes such as DIN EN 13501-1 for the classification of construction products or DIN EN 45545 for railway applications.

But also, for many other fire tests, where the heat release is not explicitly determined, it is highly advantageous if materials release little heat in case of fire.

Often, the qualification of materials for certain applications is tied to specific properties, particularly mechanical resistance, but also hydrolysis stability, aging stability, UV stability, resistance to certain chemicals or oils, temperature application range, or processability.

### SUMMARY OF THE INVENTION

### Problem

The problem to be solved was to develop a new thermoplastic polyurethane that exhibits low heat release with good mechanical properties, as well as aging resistance and hydrolysis resistance.

### Solution

It was surprisingly found that a flame-retardant thermoplastic polyurethane composition with a thermoplastic polyurethane based on 1,3-poly-propane diol (PO3G) polyol has a particularly lower heat release compared with other polyether polyols.

At the same time these PO3G polyol-based polyurethanes materials show overall good mechanical properties, aging resistance and hydrolysis resistance and good flame retardancy.

### DETAILED DESCRIPTION OF THE INVENTION

In an embodiment 1 the invention is directed to a thermoplastic polyurethane composition, wherein the thermoplastic polyurethane is the reaction product of at least the following building components
a) diisocyanate
b) poly-propane diol
c) chain extender
and the composition further comprises a flame retardant, preferably the flame retardant comprises phosphorus.

### Thermoplastic Polyurethane

The term composition indicates that the composition does not comprise the thermoplastic polyurethane only, but may comprise several polymers, additives and/or auxiliaries.

In a preferred embodiment 2 the thermoplastic polyurethane of the thermoplastic polyurethane composition of embodiment 1 is prepared by reacting an organic isocyanate, preferably an diisocyanate, with a poly-propane diol, preferably having a number average molecular weight of from 0.5×10³ g/mol to 100×10³ g/mol and a chain extender preferably having a molecular weight of from 0.05×10³ g/mol to 0.499×10³ g/mol, if desired in the presence of a catalyst, an auxiliary, and an additive, or a mixture thereof.

The components organic isocyanate, preferably diisocyanate, the poly-propane diol, and the chain extender are also addressed individually or together as building components. The building components including the catalyst and/or the auxiliary and/or the additive are also called input materials.

In order to adjust the hardness and melt index of the thermoplastic polyurethane (TPU), the molar ratios of the quantities of the building components and chain extender, can be varied, whereby the hardness and melt viscosity increase with increasing content of isocyanate or with increasing content of isocyanate and chain extender, while the melt flow index decreases.

In a preferred embodiment 3 according to any of the precedent embodiments or one of their preferred embodiments, the thermoplastic polyurethane composition has a Shore A hardness of less than 95, preferably from 75 to 95.

In a preferred embodiment 4 according to any of the precedent embodiments or one of their preferred embodiments, in order to prepare the thermoplastic polyurethane, the building components isocyanate, poly-propane diol and the chain extender, are reacted in the presence of a catalyst, and optionally auxiliaries and/or additives in such quantities that the equivalent ratio of NCO groups of the isocyanate, preferably the diisocyanate, to the sum of the hydroxyl groups of the poly-propane diol and the chain extender is 0.95 to 1.10:1, preferably 0.98 to 1.08:1 and in particular approximately 1.0 to 1.05:1. In a very preferred embodiment the equivalent ratio is 1.0:1.0.

In a preferred embodiment 5 according to any of the precedent embodiments or one of their preferred embodiments, the thermoplastic polyurethane has a weight-average molecular weight of at least 0.04×10⁶ g/mol, more preferably at least 0.06×10⁶ g/mol, more preferably at least 0.07×10⁶ g/mol, and more preferably at least 0.08×10⁶ g/mol. The upper limit for the weight-average molecular weight of thermoplastic polyurethane (TPU) is generally determined by the processability and the desired range of properties. Preferably the weight-average molecular weight of the thermoplastic polyurethane does not exceed 0.5×10⁶ g/mol, more preferably 0.4×10⁶ g/mol, more preferably 0.25×10⁶ g/mol, and more preferably 0.2×10⁶ g/mol. The mean molecular weights and the weight-average molecular weight as outlined herein are determined by gel permeation chromatography, preferably according to DIN 55672-1, whereas dimethylformamide (DMF) is used as solvent.

### Isocyanate

In a preferred embodiment 6 according to any of the precedent embodiments or one of their preferred embodiments, the isocyanate is an organic isocyanate, more preferred is an organic diisocyanate. Further preferred the isocyanate is selected from the group consisting of aliphatic, cycloaliphatic, araliphatic and aromatic isocyanates, or is a mixture thereof.

In a preferred embodiment the isocyanate is selected from the group comprising tri-, tetra-, penta-, hexa-, hepta- and/or octamethylene diisocyanate, 2-methyl-pentamethylene 1,5-diisocyanate, 2-ethyl-butylene-1,4-diisocyanate, 1,5-pentamethylene diisocyanate (PDI), 1,4-butylenediisocyanate, 1-isocyanato-3,3,5-trimethyl-5-isocyanatomethyl-cyclohexane (isophorone diisocyanate, IPDI), 1,4-bis(isocyanatomethyl)cyclohexane and/or 1,3-bis(isocyanatomethyl)cyclohexane (HXDI), 2,4-paraphenylene diisocyanate (PPDI), 2,4-tetramethylene xylene diisocyanate (TMXDI), 4,4′-, 2,4′- and 2,2′-dicyclohexylmethane diisocyanate (H12MDI), 1,6-hexamethylene diisocyanate (HDI), 1,4-cyclohexane diisocyanate, 1-methyl-2,4- and/or -2,6-cyclohexane diisocyanate, 2,2′-, 2,4′- and/or 4,4′-diphenylmethane diisocyanate (MDI), 1,5-naphthylene diisocyanate (NDI), 2,4- and/or 2,6-toluene diisocyanate (TDI), 3,3′-dimethyl-diphenyl diisocyanate, 1,2-diphenylethane diisocyanate and/or phenylene diisocyanate, or is a mixture thereof. Aliphatic isocyanates are preferred when stability against electromagnetic waves e.g. light is of importance, whereas aromatic polyisocyanate is preferred when high mechanical strength of the polyurethane, especially the thermoplastic polyurethane is required. A further advantage of aliphatic isocyanate is that it may be produced bio-based.

A very preferred aliphatic isocyanate is 1,5-pentamethylene diisocyanate. This has the additional advantage, that it can be produced bio based.

A very preferred aromatic isocyanate is 2,2′-, 2,4′-, or 4,4′-diphenylmethane diisocyanate (MDI), or is a mixture thereof, especially preferred is 4,4′-diphenylmethane diisocyanate.

### Polyol

In a preferred embodiment 7 according to any of the precedent embodiments or one of their preferred embodiments, the poly-propane diol is a 1,3-poly-propane diol. The number average molecular weight of the poly-propane diol, preferably the poly-1,3-propane diol, preferably is between 0.5×10³ g/mol and 8×10³ g/mol, more preferably between 0.7×10³ g/mol and 4.0×10³ g/mol, more preferably between 0.8×10³ g/mol and 3.2×10³ g/mol, more preferably between 0.8×10³ g/mol and 2.2×10³ g/mol, even more preferred between 0.8×10³ g/mol and 1.2×10³ g/mol.

The poly-propane diol is a single compound or is a mixture of different compounds, in which the mixture meets the above requirement; preferably it is a single compound, more preferably it is poly 1,3-propaned-diol.

### Chain Extender

Further a chain extender is used as a building component in the synthesis of the thermoplastic polyurethane. In a preferred embodiment 8 according to any of the precedent embodiments or one of their preferred embodiments, the chain extender is an aliphatic, araliphatic, aromatic or cycloaliphatic compound, or is a mixture thereof, preferably with a molecular weight of 0.05×10³ g/mol to 0.499×10³ g/mol. The chain extender preferably has 2 groups reactive with isocyanate. These groups are also referred to as functional groups. The chain extender is either a single chain extender or a mixture of at least two chain extenders.

The chain extender is preferably a difunctional compound, preferred examples being diamines or alkane diols having 2 to 10 carbon atoms in the alkylene radical, or a mixture thereof.

In a preferred embodiment 9 according to any of the precedent embodiments or one of their preferred embodiments, the chain extender is selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, di-, tri-, tetra-, penta-, hexa-, hepta-, okta-, nona- and/or deca alkylene glycole dipropylene glycol, 1,4-cyclohexanediol, 1,4-dimethanol cyclohexane, neopentylglycol and hydroquinone bis(beta-hydroxyethyl) ether (HQEE), or is a mixture thereof.

In a preferred embodiment 10 according to any of the precedent embodiments or one of their preferred embodiments, the chain extender is selected from the group consisting of 1,2-ethylene glycol, 1,3-propanediol, 1,4-butanediol, and 1,6-hexanediol, di-, tri-, tetra-, penta-, hexa-, hepta-, okta-, nona-andr deca alkylene glycole, preferably respective oligo- and polyalkylene or polypropylene glycole, or is a mixture thereof.

In a preferred embodiment 11 according to any of the precedent embodiments or one of their preferred embodiments, the chain extender is 1,2-ethylendiol, 1,3-propanediol, 1,4-butanediol or 1,6-hexanediol, more preferred are 1,3-propanediol or 1,4-butanediol, or a mixture thereof.

In one very preferred embodiment 12 according to any of the precedent embodiments or one of their preferred embodiments the chain extender is 1,4-butanediol.

### Catalyst

Catalysts (d) which, in particular, accelerate the reaction between the NCO groups of the isocyanates (a) and the hydroxyl groups of the polyol and the chain extender, are used in preferred embodiments.

In a preferred embodiment 13 according to any of the precedent embodiments or one of their preferred embodiments, the catalyst is selected from the group consisting of tertiary amine and organic metal compound, or is a mixture thereof.

A preferred tertiary amine is selected from the group consisting of triethylamine, dimethylcyclohexylamine, N-methylmorpholine, N,N′-dimethyl-piperazine, 2-(dimethylaminoethoxy) ethanol, diazabicyclo[2.2.octane] or is a mixture thereof.

A preferred organic metal compound is selected from the group consisting of titanic ester, iron compound, tin compound, and bismuth salt, or is a mixture thereof. A preferred iron compound is iron(III) acetylacetonate. A preferred tin compound is selected from the group consisting of tin diacetate, tin dioctoate, tin dilaurate and dialkyl tin salts of aliphatic carboxylic acids, preferably tin dioctoate, or is a mixture thereof. A preferred titanic ester is tetrabutyl orthotitanate. In preferred bismuth salts, the bismuth is present in the oxidation states 2 or 3, in particular 3, with preference being given to salts of carboxylic acids, preferably carboxylic acids having from 6 to 14 carbon atoms, particularly preferably from 8 to 12 carbon atoms. A very preferred bismuth salt is bismuth (III) neo-decanoate, bismuth 2-ethylhexanoate, or bismuth octanoate, or is a mixture thereof.

In a preferred embodiment 14 according to any of the precedent embodiments or one of their preferred embodiments, the catalysts is used in an amount of from 0.0001 to 0.1 part by weight per 100 parts by weight of the compound reactive toward isocyanates. In a preferred embodiment 15 according to any of the precedent embodiments or one of their preferred embodiments, the catalyst is a tin dioctoate, more preferred tin (II) 2-ethylhexanoate (SDO), preferably used in quantities of 0.35-0.4 parts per weight, referring to the composition.

### Auxiliary

In a preferred embodiment 16 according to any of the precedent embodiments or one of their preferred embodiments, beside the flame retardant an additional auxiliary or additive is comprised in the composition. In a preferred embodiment the auxiliary or additive is selected from surface-active substances, fillers, nucleating agents, oxidation stabilizers, lubricating, demolding aids, dyes, pigments, stabilizers, preferably against hydrolysis, light, heat or discoloration, inorganic fillers, organic fillers, reinforcing agents, plasticizers, or is a mixture thereof.

Stabilizers in the sense of this invention are additives which protect a plastic or a plastic composition against harmful environmental influences. Preferred examples are primary and secondary antioxidants, sterically hindered phenols, hindered amine light stabilizers, UV absorbers, hydrolysis inhibitors, quenchers or are mixtures thereof. Examples of commercially available stabilizers are given in Plastics Additives Handbook, 5th Edition, H. Zweifel, ed., Hanser Publishers, Munich, 2001 ([1]), p. 98-S136.

In a preferred embodiment, the UV absorber has a number average molecular weight greater than 0.3×10³ g/Mol, in particular greater than 0.39×10³ g/Mol. Furthermore, the preferred UV absorber has a molecular weight not exceeding 5×10³ g/Mol, particularly preferred not exceeding 2×10³ g/mol.

The UV absorber is preferably selected from the group consisting of cinnamates, oxanilides and benzotriazole, or is a mixture thereof, particularly suitable as UV absorbers is benzotriazole. Examples of particularly suitable UV-absorbers are Tinuvin® 213, Tinuvin® 234, Tinuvin® 312, Tinuvin® 571, Tinuvin® 384 and Eversorb® 82.

Preferably the UV absorbers is added in quantities of 0.01 wt. % to 5 wt. % based on the total weight of the composition, preferably 0.1 wt. % to 2.0 wt. %, in particular 0.2 wt. % to 0.5 wt. %.

Often a UV stabilization based on an antioxidant and a UV absorber as described above is not sufficient to guarantee a good stability of the composition against the harmful influence of UV rays. In this case, in addition to the antioxidant and/or the UV absorber, or as single stabilizer, a hindered-amine light stabilizer (HALS) is added to the composition.

Examples of commercially available HALS stabilizers can be found in Plastics Additive Handbook, 5th edition, H. Zweifel, Hanser Publishers, Munich, 2001, pp. 123-136.

Particularly preferred hindered amine light stabilizers are bis-(1,2,2,6,6-penta-methylpiperidyl) sebacat (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). In particular, the condensation product of 1-hydroxyethyl-2,2,6,6-tetramethyl-4-hydroxypiperidines and succinic acid (Tinuvin® 622) is preferred, if the titanium content of the finished product is less than 150 ppm by weight, preferably less than 50 ppm by weight, in particular less than 10 ppm by weight, based on the components used.

HALS compounds are preferably used in a concentration of from 0.01 wt. % to 5 wt. %, particularly preferably from 0.1 wt. % to 1 wt. %, in particular from 0.15 wt. % to 0.3 wt. %, based on the total weight of the composition.

A particularly preferred UV stabilization contains a mixture of a phenolic stabilizer, a benzotriazole and a HALS compound in the preferred amounts described above.

Further information on the above-mentioned auxiliaries and additives can be found in the technical literature, e.g. Plastics Additives Handbook, 5th edition, H. Zweifel, ed., Hanser Publishers, Munich, 2001.

### Heat Release Parameter

In a preferred embodiment 17 of the composition according to any of the precedent embodiments or one of their preferred embodiments the total heat release (THR) of the composition, preferably measured according to ISO 5660 part 1 and part 2 (2002-12), is less than 160 MJ/m², horizontally measured in a cone calorimeter on 100×100×5 mm sample plates burned with 35 kW/m². More preferably the THR is less than 150 MJ/m², more preferably less than 140 MJ/m², more preferably less than 130 MJ/m², and most preferably less than 120 MJ/m².

In a preferred embodiment 18 of the composition according to any of the precedent embodiments or one of their preferred embodiments, the peak of the Heat Release Rate (pHRR) of the composition, preferably measured according to ISO 5660 part 1 and part 2 (2002-12), is less than 600 kW/m² determined with plates with a thickness of 5 mm and with 35 kW in the cone calorimeter, more preferably less than 400 kW/m². more preferably less than 300 kW/m².

### Mechanical Parameter

In a preferred embodiment 19 of the composition according to any of the precedent embodiments or one of their preferred embodiments the Shore A hardness of the composition is between 75 and 100, more preferably between 80 and 95. The Shore A hardness is preferably measured according to DIN ISO 7619-1:2016.

In a preferred embodiment 20 of the composition according to any of the precedent embodiments or one of their preferred embodiments the tensile strengths of the composition, preferably measured according to DIN 53504:2017-03, is more than 10 MPa, more preferably more than 15 MPa, even more preferably more than 20 MPa.

### Flame Retardant

### P-Containing Flame Retardant

In one preferred embodiment 21 the composition according to any of the precedent embodiments or one of their preferred embodiments the flame retardant comprises phosphorus, more preferably a phosphate radical. The flame retardant is a single substance or is a mixture of at least two flame retardants.

The amount of flame retardant in the composition preferably is between 5 weight-% and 60 weight-%, more preferably between 5 weight-% and 50 weight %, more preferably between 10 weight-% and 40 weight % referring to the whole composition being 100 weight-%.

In a preferred embodiment 22 according to any of the precedent embodiments or one of their preferred embodiments, at least one flame retardant in the composition is selected from the group consisting of a derivative of the phosphoric acid, a derivative of the phosphonic acid, a derivative of the phosphinic acid, melamine cyanurate, and metal hydroxide, or is a mixture thereof,

In a preferred embodiment 23 according to any of the precedent embodiments or one of their preferred embodiments the flame retardant comprises phosphorus, more preferred a derivative of the phosphorus acid, a derivative of the phosphonic acid or a derivative of the phosphinic acid, or a mixture thereof.

In a preferred embodiment 24 according to any of the precedent embodiments or one of their preferred embodiments the composition comprises a phosphorus acid ester as flame retardant. Preferred embodiments of the phosphorus acid ester are outlined below.

The phosphoric acid ester preferably is a tri-ester, more preferred a trialkyl phosphate. Other preferred esters are triaryl phosphates, especially preferred is triphenyl phosphate.

In another embodiment, the phosphoric ester has the general formula (I)

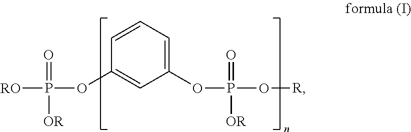

where R denotes substituted alkyl, cycloalkyl, or phenyl groups, and n is an integer in the range from 1 to 15.

If R in the general formula (I) is an alkyl moiety, alkyl moieties that preferably are used are those having from 1 to 8 carbon atoms. The cyclohexyl is a preferred example of the cycloalkyl groups. In other preferred embodiments R denotes a phenyl or alkyl-substituted phenyl.

Preferably, n is 1, or an integer from 2 to 6, preferably from 3 to 6.

More preferred the phosphoric acid ester is selected from the group consisting of resorcinol bis-diphenyl phosphate (RDP), bisphenol-A bis-(diphenyl phosphate) (BDP), and diphenylkresyl phosphate (DPK), or is a corresponding oligomer, or is a mixture thereof. The oligomer preferably has an average degree of oligomerization of n=3 to 6.

Most preferred the flame retardant comprises resorcinol bis(diphenyl phosphate) (RDP), more preferred in the form of an oligomer with an average degree of oligomerization of n=3 to 6.

In a preferred embodiment the phosphorous containing flame retardant is comprised in the composition between 5 weight-% and 60 weight-% referring to the composition being 100 weight-%. A flame retardant being a derivative of the phosphorus acid, preferably the melamine polyphosphate, preferably is comprised in an amount between 3 weight-% and 30 weight-% referring to the composition being 100 weight-%, more preferred between 5 weight-% and 10 weight-%.

A flame retardant being a derivative of the phosphonic acid or phosphoric acid preferably is comprised in an amount between 2 weight-% and 24 weight-% referring to the composition being 100 weight-%, preferably between 2 weight-% and 10 weight-%.

A flame retardant being a derivative of the phosphinic acid preferably is comprised in an amount between 5 weight-% and 30 weight-% referring to the composition being 100 weight-%, preferably between 10 weight-% and 20 weight-%.

### Metal Hydroxide

In a preferred embodiment 25 according to any of the precedent embodiments or one of their preferred embodiments the flame retardant comprises a metal hydroxide or a metal oxide hydrate, or is a mixture thereof, more preferred the metal is selected from aluminium and magnesium, or is a mixture thereof.

A preferred metal hydroxide is a hydroxide or an oxide hydrate, more preferred a hydroxide or an oxide hydrate of aluminium or a hydroxide of magnesium, or a mixture thereof. The advantage of the metal hydroxides is that in the event of fire they exclusively liberate water and therefore do not form any toxic or corrosive smoke products. Furthermore, said hydroxides are capable of reducing smoke density in the event of a fire. However, a disadvantage of said substances is that they firstly promote the hydrolysis of thermoplastic polyurethanes and secondly also have an adverse effect on the oxidative aging of the polyurethanes.

In the context of this invention, the expression oxidative aging is used when the mechanical parameters of the thermoplastic polyurethanes, e.g. tensile strength, tensile strain at break, tear-propagation resistance, flexibility, impact resistance, softness, etc., undergo adverse change over the course of time. In order to check the aging process in the laboratory, the mechanical parameters are determined first prior to high-temperature aging and secondly after appropriate aging. Preferred aging temperatures at which aging is carried out for 7 days are 113° C. or 121° C. Other temperatures and times can be used, depending on requirements.

In a preferred embodiment 26 according to any of the precedent embodiments or one of their preferred embodiments the flame retardant comprises an aluminium hydroxide or an aluminium oxide hydrate, or is a mixture thereof.

In a preferred embodiments the flame retardant comprising a metal hydroxide respectively a metal oxide hydrate, further comprises a phyllosilicate, preferably bentonite.

In a preferred embodiment 27 according to any of the embodiments 25 or 26 or one of their preferred embodiments, the content of the metal hydroxide is between 10% by weight and 80% by weight. This proportion by weight is based on the total weight of the composition. At higher fill levels, the mechanical properties of the composition are unacceptably impaired. It is therefore advantageous to add other flame retardants, in particular those comprising phosphorus. In a preferred embodiment the polyurethane comprises at least one further flame retardant beside the metal hydroxide, or the metal oxide hydrate, or their mixture. This further flame retardant preferably is a phosphorus containing flame retardant. The amount of the metal hydroxide is preferably from 10% by weight to 65% by weight, more preferably from 20% by weight to 50% by weight, and more preferably from 25% by weight to 40% by weight, referring to the total weight of the composition being 100 weight-%.

The specific surface area of the metal hydroxide preferably is from 2 m²/g to 150 m²/g, more preferably from 2 m²/g to 9 m²/g, more preferably from 3 m²/g to 8 m²/g, and particularly preferably from 3 m²/g to 5 m²/g.

The specific surface area preferably is determined by the BET method in accordance with DIN ISO 9277:2003-05, using nitrogen.

### Coating of the Metal Hydroxide or the Metal Oxide Hydrate

In another preferred embodiment 28 according to any of the embodiments 25 to 27 or one of their preferred embodiments the metal hydroxide or both are at least partly covered with a coating.

The coating at least partly covers the surface of the metal hydroxide or the metal oxide hydrate. The coating is equivalent to the frequently used expression “surface treatment”. The coating adheres on the metal hydroxide either via interlock effects or via van der Waals forces, purely physically, or has chemical bonding to the metal hydroxide. This is achieved mainly via covalent interaction.

The surface treatment or surface modification which provides a coating around the enclosed part, in the present case the metal hydroxide or the metal oxide hydrate is described in detail in the literature. “Particulate-Filled Polymer Composites” (2nd edition), edited by: Rothon, Roger N., 2003, Smithers Rapra Technology is a basic reference work which describes suitable materials, and also the coating technology. Chapter 4 is particularly relevant. Appropriate materials are available commercially, for example from Nabaltec, Schwandorf, or Martinswerke in Bergheim, both in Germany.

Preferred coating materials are saturated or unsaturated polymers using an acid function, preferably using at least one acrylic acid or one anhydride, preferably maleic anhydride. These coating materials give particularly good attachment to the surface of the metal hydroxide.

The polymer involves one polymer or a mixture of polymers, preference being given to one polymer. A preferred polymer is a polymer of mono- or diolefins, or a mixtures thereof, a copolymer of mono- and diolefins with one another or with other vinyl monomers, or polystyrene, or poly(p-methylstyrene), or poly(alpha-methylstyrene), or a copolymer of styrene or alpha-methylstyrene with a diene or with an acrylic derivative, or a graft copolymer of a styrene or an alpha-methylstyrene, or a halogen-containing polymer, or a polymers which derives from alpha- or beta-unsaturated acids, or from a derivative of these, or a copolymer of one of these monomers with one another or with other unsaturated monomers, or is a mixture thereof.

Another preferred coating material is a monomeric organic acid or their derivative. The acid preferably is a saturated acid, more preferably an aliphatic acid, more preferably a saturated fatty acid.

A preferred fatty acid comprises from 10 to 30 carbon atoms, preferably from 12 to 22 carbon atoms, in particular from 16 to 20 carbon atoms, and more preferably has no double bond. Stearic acid is very particularly preferred.

A preferred fatty acid derivative is their salt, preferably the salt is a calcium, an aluminium, a magnesium or a zinc salt. Particular preference is given to the calcium salt, in particular to calcium stearate.

### Organosilane Coating

Another preferred material for the coating around the metal hydroxide, or the metal oxide hydrate, is an organosilane, preferably having the following structure:

(R)₄₋ₙ———Si———Xₙ, where n=1, 2, or 3.

X is a hydrolysable group which reacts with the surface of the metal hydroxide, also being termed a coupling group. X preferably is a halogen, preferably chlorine, and the coupling reagent is accordingly a tri-, di-, or monochlorosilane. It is more preferable that the coupling group X is an alkoxy group, more preferably a methoxy group or an ethoxy group, or a mixture thereof. It is preferable that the moiety R is a hydrocarbon moiety and that its selection is such that the organosilane compound has good miscibility with the thermoplastic polyurethane.

The moiety R preferably has a bonding to the silicon by way of a hydrolytically stable carbon-silicon bond, and is either reactive or inert. A preferred example of a reactive moiety R, is an unsaturated hydrocarbon moiety, more preferably is an allyl moiety. It is preferable that the moiety R is inert, and it is more preferably a saturated hydrocarbon moiety having from 2 to 30 carbon atoms, preferably having from 6 to 20 carbon atoms, and particularly preferably having from 8 to 18 carbon atoms, and it is more preferably a branched-chain or linear aliphatic hydrocarbon moiety.

It is more preferable that the organosilane compound comprises only one moiety R and has the general formula:

R———Si———(X)₃

X preferably is a halogen, preferably chlorine, and the coupling reagent is accordingly a tri-, di-, or monochlorosilane. It is more preferable that the coupling group X is an alkoxy group, more preferably a methoxy group or an ethoxy group, or a mixture thereof.

It is very preferable that the moiety is the hexadecyl radical, preferably using the methoxy coupling group or ethoxy coupling group, the organosilane thus being the hexadecylsilane.

The amounts of the silanes applied to the metal hydroxide are from 0.1% by weight to 5% by weight, more preferably from 0.5% by weight to 1.5% by weight, and particularly preferably about 1% by weight, based on the total amount of the metal hydroxide or metal oxid hydroxid.

The amounts of the carboxylic acids and carboxylic acid derivatives applied to the metal hydroxide are from 0.1% by weight to 5% by weight, more preferably from 1.5% by weight to 5% by weight, and particularly preferably from 3% by weight to 5% by weight, based on the total amount of the metal hydroxide.

It is preferable that the maximum dimension of more than 50%, more preferably more than 70%, more preferably more than 90%, of the metal hydroxides surrounded at least to some extent by a coating and preferably taking the form of powders is less than 10 μm, preferably less than 5 μm, particularly preferably less than 3 μm. At the same time, at least one maximum dimension of at least 50% of the particles, preferably at least 70%, more preferably at least 90%, is more than 0.1 μm, more preferably more than 0.5 μm, and particularly preferably more than 1 μm.

Preferable for the composition of the invention previously coated metal hydroxides or metal oxide hydrates are used. This is the only way of avoiding undesired side reactions of the coating materials with the constituents of the composition and is a particularly effective way of providing the advantage of inhibiting oxidative degradation of the thermoplastic polyurethane. The coating of the metal hydroxide or metal oxide hydrate in a preferred embodiment takes place in the feed region of the extruder, before the polyurethane is added in a downstream portion of the extruder.

In a preferred embodiment 29 according to any of the embodiments 1 to 28 or one of their preferred embodiments the composition comprises as flame retardant a phosphorus acid ester as outlined and preferred herein, and a metal hydroxide as outlined and preferred herein. In a more preferred embodiment 30 the flame retardant comprises a metal hydroxide or a metal oxide hydrate, wherein the metal is selected from aluminium and magnesium, and a derivative of the phosphoric acid, as preferred below. Very preferred the phosphoric ester is selected from the group consisting of resorcinol bis-diphenyl phosphate (RDP), bisphenol-A bis-(diphenyl phosphate) (BDP), and diphenylkresyl phosphate (DPK), or is a corresponding oligomer, or is a mixture thereof. The oligomer preferably has an average degree of oligomerization of n=3 to 6.

In a preferred embodiment 31 according to any of the embodiments 1 to 28 or one of their preferred embodiments, the flame retardant comprises a aluminium hydroxide or an aluminium oxide hydrate as preferred herein, and resorcinol bis(diphenyl phosphate) (RDP), more preferred in the form of an oligomer, more preferred with an average degree of oligomerization of n=3 to 6.

In a preferred embodiment 32 according to any of the embodiments 1 to 28 or one of their preferred embodiments the flame retardant comprises a metal hydroxide or a metal oxide hydrate, or a mixture thereof, more preferred the metal is selected from aluminium and magnesium, or is a mixture thereof, the phosphoric ester is selected from the group consisting of resorcinol bis-diphenyl phosphate (RDP), bisphenol-A bis-(diphenyl phosphate) (BDP), and diphenylkresyl phosphate (DPK), or is a corresponding oligomer, or is a mixture thereof, wherein the oligomer preferably has an average degree of oligomerization of n=3 to 6, and the flame retardant further comprises a derivative of the phosphinic acid as preferred herein, most preferred aluminium diethyl phosphinate.

The metal hydroxide, the metal oxide hydrate, or a mixture thereof is comprised in the composition in the range between 10 weight-% and 60 weight-%, referring to the whole composition, preferably between 33 weight-% and 60 weight-%, referring to the whole composition.

In a preferred embodiment 33 according to any of the precedent embodiments, preferably according to embodiments 1 to 22, or one of their preferred embodiments, the flame retardant comprises a derivative of the phosphoric acid, more preferred a phosphoric acid ester.

The phosphoric acid ester preferably is a tri-ester, more preferred a trialkyl phosphate. Other preferred esters are triaryl phosphates, especially preferred is triphenyl phosphate.

In another embodiment, the phosphoric ester has the general formula (I)

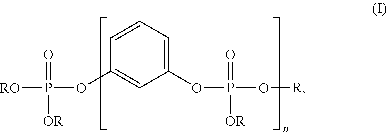

where R denotes substituted alkyl, cycloalkyl, or phenyl groups, and n is an integer in the range from 1 to 15.

If R in the general formula (I) is an alkyl moiety, alkyl moieties that preferably are used are those having from 1 to 8 carbon atoms. The cyclohexyl is a preferred example of the cycloalkyl groups. In other preferred embodiments R denotes a phenyl or alkyl-substituted phenyl.

Preferably, n is 1, or an integer from 2 to 6, preferably from 3 to 6.

More preferred the phosphoric acid ester is selected from the group consisting resorcinol bis-diphenyl phosphate (RDP), bisphenol-A bis-(diphenyl phosphate) (BDP), and diphenylkresyl phosphate (DPK), or is a corresponding oligomer, or is a mixture thereof. The oligomer preferably has an average degree of oligomerization of n=3 to 6.

Most preferred the flame retardant comprises resorcinol bis(diphenyl phosphate) (RDP), more preferred in the form of an oligomer with an average degree of oligomerization of n=3 to 6.

The derivative of the phosphoric ester preferably is comprised in the composition in the range between 2 weight-% and 15 weight-% referring to the whole composition, preferably in the range between 2 weight-% and 10 weight-%.

In a preferred embodiment 34 the composition according to any of the precedent embodiments, preferably according to embodiments 1 to 22 or 33, or one of their preferred embodiments, the flame retardant comprises melamine cyanurate. The melamine cyanurate is comprised in the composition in the range between 5 weight-% and 40 weight-% referring to the total amount of the composition, preferably between 20 weight-% and 30 weight-%:

In a preferred embodiment 35 the composition according to any of the precedent embodiments, preferably according to embodiments 1 to 22 or 33 to 34, or any of their preferred embodiments, comprises melamine cyanurate and a derivative of the phosphoric acid, more preferred the phosphoric ester is selected from the group consisting of 1,3-phenylene bis(diphenyl)phosphate, 1,3-phenylene bis(dixylenyl)phosphate, or is a corresponding oligomer, or is a mixture thereof. The oligomer preferably has an average degree of oligomerization of n=3 to 6.

In a preferred embodiment 36 the composition according to any of the precedent embodiments, preferably according to embodiments 1 to 22 or 33 to 35, or any of their preferred embodiments, comprises melamine cyanurate and resorcinol bis(diphenyl phosphate) (RDP), more preferred RDP is in the form of an oligomer with an average degree of oligomerization of n=3 to 6. RDP preferably is comprised in the composition in the range between 2 weight-% and 15 weight-%, referring to the whole composition, preferably between 2 weight-% and 10 weight-% in the melamine cyanurate in the range between 5 weight-% and 40 weight-% referring to the total amount of the composition, preferably between 20 weight-% and 30 weight-%.

### Phosphinic Acid Derivative

In a preferred embodiment 37 the composition according to any of the precedent embodiments or one of their preferred embodiments comprises a derivative of the phosphinic acid.

One preferred phosphinic acid derivative has the general formula (II) R1R2(P═O)OR3, where all three groups R1, R2 and R3 in one preferred embodiment are identical or in another preferred embodiment are different from each other. The groups R1, R2 and R3 preferably are hydrogen or are organic groups in one preferred embodiment aliphatic in another preferred embodiment aromatic, and more preferably have from 1 to 20 carbon atoms, more preferably from 1 to 10 carbon atoms, more preferred the alkyl group is selected from of methyl-, ethyl-, propyl-, butyl-, pentyl, heptyl-, octyl, nonyl-, decyl-radical, or is a mixture thereof.

In one preferred embodiment the organic ester is an alkyl ester, in another preferred embodiment an aryl ester. Very preferred all hydroxy groups of the phosphinic acid are esterified. Preferably at least one of the organic groups is aliphatic, and it is more preferable that all of the organic groups are aliphatic.

In one preferred embodiment the R1, R2 or R3 has from 1 to 3 carbon atoms, or is hydrogen. In one preferred embodiment R1 and R2 are ethyl moieties, more preferably in this embodiment R3 is also an ethyl radical or is a methyl radical. In one preferred embodiment, R1, R2 and R3 are simultaneously either an ethyl radical or a methyl radical.

In another preferred embodiment R1, R2 and R3 each is a hydrogen atom.

### Phosphinates

Another preferred embodiment of the phosphinic acid derivative is a phosphinate. A phosphinate is a salt of a phosphinic acid with an organic or inorganic cation. The groups R1 and R2 of formula (II) are either aliphatic or aromatic, and preferably have from 1 to 20 carbon atoms, more preferably from 1 to 10, more preferably from 1 to 3. Preferably at least one of the groups R1 or R2 is aliphatic, more preferred R1 and R2 are aliphatic, and very preferred R1 and R2 are ethyl groups. In other preferred embodiments R1 and R2 are hydrogen.

Preferred salts of phosphinic acids are metal hypophosphite salts, such as alkali metal salts, alkaline earth metal salts, aluminium, calcium, titanium, zinc salts, or mixtures thereof, more preferred is aluminium or zink, or a mixture thereof, more preferred is aluminium.

The most preferred phosphinate is aluminium diethyl phosphinate.

### Preferred Combinations

In a preferred embodiment 38 of the composition according to any of the precedent embodiments, preferably one of the embodiments 1 to 22, or one of their preferred embodiments, the flame retardant comprises melamine cyanurate and a derivative of the phosphoric acid, preferably as preferred above, and a derivative of the phosphinic acid, preferably as preferred above.

In a very preferred embodiment 39 of the composition according to any of the precedent embodiments, preferably according to one of embodiments 1 to 22, or one of their preferred embodiments, the flame retardant comprises melamine cyanurate and resorcinol bis(diphenyl phosphate) (RDP), more preferred RDP is in the form of an oligomer with an average degree of oligomerization of n=3 to 6, and aluminium diethyl phosphinate.

### Melamine Polyphosphate

In a preferred embodiment 40 the composition according to any of the precedent embodiments, preferably according to embodiments 1 to 22, or one of their preferred embodiments the flame retardant comprises melamine polyphosphate. Melamine polyphosphate is another preferred derivative of the phosphoric acid.

Preferably the melamine polyphosphate has a phosphorus content in the range from 7% by weight to 20% by weight, preferably in the range from 10% by weight to 17% by weight, more preferably in the range from 12% by weight to 14% by weight, referring to the total weight of the melamine polyphosphate.

In In a preferred embodiment 41 according to any of the precedent embodiments, preferably according to embodiments 1 to 22 or 40, or one of their preferred embodiments, the melamine polyphosphate is present in the composition in an amount between 2% by weight and 35% by weight based on the weight of the total composition being 100 weight-%, in particular in the range from 3% by weight to 30% by weight, more preferably in the range from 4% by weight to 25% by weight, more preferred in the range from 5% by weight to 20% by weight, even more preferred in the range from 5% by weight to 10% by weight.

In a preferred embodiment 42 the composition according to any of the precedent embodiments, preferably according to embodiments 1 to 22 or 40 to 41, or one of their preferred embodiments is free from melamine cyanurate. “Free from melamine cyanurate” preferably means that the composition comprises less than 5% by weight of melamine cyanurate, more preferably less than 1% by weight, more preferably less than 0.5% by weight, more preferably less than 0.01% by weight, more preferably less than 50 ppm by weight, preferably less than 20 ppm by weight. In a very preferred embodiment, the composition comprises 0 ppm of melamine cyanurate.

In one preferred embodiment 43 of the composition according to any of the precedent embodiments, preferably according to embodiments 1 to 22 or 40 to 42, or one of their preferred embodiments the flame retardant comprises a derivative of the phosphinic acid, more preferred the flame retardant comprises melamine polyphosphate as outlined and preferred above and a derivative of the phosphinic acid, preferably as outlined and preferred as follows.

It is preferable that the derivative of phosphinic acid is selected from salts comprising an organic or inorganic cation or from organic esters

Phosphinic esters have the general formula R1R2(P═O)OR3, wherein all three organic groups R1, R2 and R3 may be identical or different. The radicals R1, R2 and R3 are either aliphatic or aromatic and preferably have 1 to 20 carbon atoms, more preferably 1 to 10, more preferably 1 to 3. Preferably at least one of the radicals is aliphatic, preferably all of the radicals are aliphatic, very particularly preferably R1 and R2 are ethyl radicals. It is more preferable when R3 too is aliphatic and more preferably an ethyl radical or a methyl radical. In a preferred embodiment R1, R2 and R3 are simultaneously ethyl radicals or methyl radicals.

Other preferred derivatives of the phosphinic acid are phosphinates, i.e. the salts of phosphinic acid with the general formula: R1R2(P═O)O—. The R1 and R2 radicals are either aliphatic or aromatic. Further preferred R1 and R2 independently have 1 to 20 carbon atoms, preferably 1 to 10, more preferably 1 to 3. Preferably at least one of the R1 or R2 radical is aliphatic, preferably both radicals are aliphatic, very preferably R1 and R2 are ethyl radicals. Preferred salts of phosphinic acids are aluminium salts, calcium salts or zinc salts, or mixtures thereof, more preferably aluminium salts or zinc salts.

In a preferred embodiment 44 of the compositions according to any of the precedent embodiments, preferably according to embodiments 1 to 22 or 40 to 43, or one of their preferred embodiments the flame retardant comprises diethyl aluminium phosphinate, preferably in an amount of 3 weight-% to 30 weight-%, referring to the total amount of the composition. Even more preferred the flame retardant comprises diethyl aluminium phosphinate and melamine polyphosphate.

In a preferred embodiment 45 of the composition according to any of the precedent embodiments, preferably according to embodiments 1 to 22 or 40 to 44, or one of their preferred embodiments the derivative of the phosphinic acid is an alkali metal hypophosphite salt. The salt preferably is an alkali metal salt, an alkaline earth metal salt, or is a mixture thereof. A preferred earth metal salt is selected from aluminium salt, titanium salt, zinc salt, or is a mixture thereof. More preferred the flame retardant comprises an aluminium hypophosphite salt or calcium hypophosphite salt, or is a mixture thereof.

In a preferred embodiment the content of the derivative of the phosphinate acid in the composition is in the range from 5% by weight to 45% by weight based on the total composition, in particular 7% by weight to 40% by weight, more preferably in the range from 8% by weight to 38% by weight, more preferably in the range from 10% by weight to 35% by weight, more preferably in the range from 12% by weight to 32% by weight, particularly preferably in the range from 15% by weight to 30% by weight based on the total composition.

In a preferred embodiment 46, the composition according to any of the precedent embodiments, preferably according to embodiments 1 to 22 or 40 to 45, or one of their preferred embodiments the amount of the whole flame retardant is between 5% by weight and 50% by weight, more preferred between 7% by weight and 40% by weight based on the weight of the total composition.

In a preferred embodiment the flame retardant has an average particle diameter D50 in the range between 0.1 μm and 100 μm, preferably between 0.5 μm and 60 μm, particularly preferably between 3 μm and 50 μm. The particles preferably have an average particle diameter D99 of less than 100 μm, more preferably of less than 90 μm. The flame retardant more preferably has an average particle diameter D50 in the range from 0.1 μm to 100 μm and an average particle diameter D99 of less than 100 μm. The particle size distribution is monomodal or else multimodal, more preferred bimodal.

The melamine polyphosphate preferably consists of particles typically having an average particle diameter D50 in the range from 0.1 μm to 100 μm, preferably from 0.5 μm to 60 μm, particularly preferably from 1 μm to 10 μm.

In a preferred embodiment the aluminium diethylphosphinate has an average particle diameter D50 in the range between 20 μm and 80 μm, preferably between 20 μm and 40 μm.

In a preferred embodiment 47 the composition according to one of the precedent embodiments, preferably according to embodiments 1 to 22 or 40 to 46, or one of their preferred embodiments comprises a further flame retardant.

In a preferred embodiment 48 according to one of the precedent embodiments, preferably according to embodiments 1 to 22, or 40 to 47, or one of their preferred embodiments the flame retardant comprises melamine polyphosphate as outlined and preferred above, a salt of the phosphinic acid or a derivate of the phosphinic acid as outlined and preferred above and at least one further flame retardant.

This further flame retardant is either a single substance or is a mixture of at least two flame retardants. A very preferred further flame retardant is liquid at 21° C.

Preferably the further flame retardant comprises a further phosphorus-containing flame retardant, more preferred a derivative of phosphoric acid or phosphonic acid, or a mixture thereof. This improves the workability of the composition. The composition preferably contains the further flame retardant, preferably the further phosphorus-containing flame retardant. Preferably the amount of all phosphorous containing flame retardants in the composition is in the range between 2% by weight and 10% by weight, referring to the whole amount of the composition.

It is preferable when the derivative of the phosphoric acid or the phosphonic acid is a salt, preferably having an organic or an inorganic cation, or is an organic ester. A organic ester is a derivative of a phosphorus-containing acid in which at least one oxygen atom directly bonded to the phosphorus is esterified with an organic radical. In a preferred embodiment the organic ester is an alkyl ester, in another preferred embodiment an aryl ester, or is a mixed alkyl-/aryl-ester. It is particularly preferable when all hydroxyl groups of the corresponding phosphorus-containing acid are esterified. Examples of preferred phosphoric acid esters include 1,3-phenylene bis(diphenyl)phosphate, 1,3-phenylene bis(di-xylenyl)phosphate and the corresponding oligomeric products having an average degree of oligomerization of n=3 to 6. A preferred resorcinol is resorcinol bis(diphenyl phosphate) (RDP). This resorcinol preferably is in the form of an oligomer.

Further preferred phosphorus-containing flame retardants are bisphenol A bis(diphenyl phosphate) (BDP) and diphenylcresyl phosphate (DPC). Bisphenol A bis(diphenyl phosphate) (BDP) preferably is in the form of an oligomer.

The preferred embodiments of flame retardant respectively mixtures of flame retardants result in better flame retardant performance together with overall good mechanical properties of the composition.

In a preferred embodiment 49 the composition according to one of the precedent embodiments or its preferred embodiments or one of their preferred embodiments has a phenol content of less than 100 ppm by weight referring to the whole amount of the composition, preferably less than 50 ppm by weight, more preferably less than 20 ppm by weight, and particularly preferably less than 10 ppm by weight. For more details also see WO 2015/121504, herein incorporated by reference. The advantage is a better hydrolysis resistance of the composition.

### Production Process

Another aspect of the invention and embodiment 50 is the production of the composition comprising a thermoplastic polyurethane according to any of the precedent embodiments, preferably according to embodiments 1 to 22, 23 to 32, 33 to 39, or 40 to 49, or one of their preferred embodiments.

The composition comprising the thermoplastic polyurethane in an embodiment comprising all features of one of the embodiments outlined above or one of their preferred embodiments is produced discontinuously or continuously. A preferred process for producing thermoplastic polyurethane is the reaction extruder process, the belt line process, the “one shot” process, preferably the “one-shot” process or the reaction extruder process, most preferably the reaction extruder process.

These processes are used either by directly mixing the building components or alternatively by applying the prepolymer process.

Polyisocyanate prepolymers are obtainable by reacting above-described polyisocyanate in excess, at temperatures of 30° C. to 100° C., preferably at 8×10° C., with the poly-propane diol.

In the “one-shot” process, the building components diisocyanate and poly-propane diol, and also the chain extender, are mixed with each other. This is done either in succession or simultaneously, in a preferred embodiment in the presence of the catalyst. In the extruder process, the building components diisocyanate and diol, in a preferred embodiment also the chain extender, and, in further preferred embodiments, also the catalyst are mixed. The mixing in the reaction extruding process is done preferably at temperatures between 100° C. and 280° C., preferably between 140° C. and 250° C. The thermoplastic polyurethane obtained, preferably is in the form of a granulate or a powder. Auxiliaries and additives may be added during the synthesis of the themoplastic polyurethane or are added to the thermoplastic polyurethane. The latter is preferred. This is especially the case, if the additive or auxiliary is not inert against the isocyanate, the chain extender, the compound reactive with isocyanate, or the catalyst.

The auxiliaries in one embodiment are added during synthesis of the thermoplastic polyurethane. In another preferred embodiment the auxiliary is added to the thermoplastic polyurethane after its synthesis.

In a preferred embodiment the synthesis of the thermoplastic polyurethane is done in an extruder, more preferably a twin-screw extruder is used. The twin-screw extruder operates with positive conveying and thus allows a more precise setting of the temperature and output quantity on the extruder.

Preferably the thermoplastic polyurethane is produced in a first step and the further components of the composition, preferably the flame retardant, are added by at least one further step. Preferably the further components are mixed with the thermoplastic polyurethane in an extruder.

In a preferred embodiment 51 the thermoplastic polyurethane composition according to one of the embodiments 1 to 49, preferably according to embodiments 1 to 22, 23 to 32, 33 to 39, or 40 to 49, or one of its preferred embodiments, respectively derived by a process according to embodiment 50 or one of its preferred embodiments is in the form of a pellet or a powder. The pellet or powder in a preferred embodiment is a compact material. In another preferred embodiment the pellet is expanded material, also referred to as foamed beads or foamed powder. Beads, respectively expanded beads in a preferred embodiment refers to particles with a maximal extension between 1 mm and 5 cm. Powder in a preferred embodiment refers to particles with a maximum size of 1 mm. Preferably the size of the powder is between 1×10⁻⁶ m and 1 mm.

Another aspect of this invention and embodiment 52 therefore is a foamed bead made of the composition according to one of the embodiments 1 to 49, preferably according to embodiments 1 to 22, 23 to 32, 33 to 39, or 40 to 49, or one of its preferred embodiments, respectively derived by any the processes according to embodiment 50 or one of its preferred embodiments.

The foamed beads and also molded bodies produced therefrom may be used in various applications (see e.g. WO 94/20568, WO 2007/082838 A1, WO2017030835, WO 2013/153190 A1, WO2010010010), herein incorporated by reference.

### Use for Producing an Article

Another aspect of the invention and embodiment 53 is the use of the composition according to one of the embodiments 1 to 49, preferably according to embodiments 1 to 22, 23 to 32, 33 to 39, or 40 to 49, or one of its preferred embodiments, respectively derived by any the processes according to embodiment 50 or one of its preferred embodiments for producing an article.

The composition in a preferred embodiment is injection moulded, calendered, powder sintered, or extruded to form an article.

Yet another aspect of the invention and embodiment 54 is the article produced with a composition according to one of the embodiments 1 to 49, preferably according to embodiments 1 to 22, 23 to 32, 33 to 39, or 40 to 49, or one of its preferred embodiments, respectively derived by any the processes according to embodiment 50 or one of its preferred embodiments.

Preferably the article is selected from the group consisting of cable, cases, cell-phone, coating, covers, damping element, bellows, foil, fiber, film moulded body, roofing or flooring for buildings or vehicles, non woven fabric, gasket, packaging material, roll, shoe sole, middle sole of a shoe, hose, cable, cable connector, cable sheathing, pillow, laminate, phone, profile, strap, saddle, foam, by additional foaming of the preparation, plug connection, television, trailing cable, solar module, lining in automobiles, wiper blade, elevator load bearing members, roping arrangements, drive belts for machines, preferably passenger conveyer, handrails for passenger conveyers modifier for thermoplastic materials, which means substance that influences the properties of another material. Each of these articles itself is a preferred embodiment, also referred to as an application.

In a very preferred embodiment, the article is a cable sheathing.

### Foaming

In one preferred embodiment the composition in the article is compact. Compact in preferred embodiments means that the density is more than 0.9 kg/L.

In another preferred embodiment the composition in these articles is foamed. The foamed article in one preferred embodiment is produced by connecting expanded beads or expanded powder. In other words the article is produced by pre-foamed precursors, which preferable are expanded beads or expanded powder.

In yet another embodiment the foamed article is produced from a compact composition further comprising a blowing agent, preferably by injection moulding, calendering, powder sintering, or extruding.

The blowing agent used for expanding the beads or the powder, respectively the compact material is either a chemical blowing agent or a physical blowing agent.

The bulk density of the foamed article preferably is from 50 g/L to 800 g/L, more preferred from 50 g/L to 500 g/L, more preferred from 50 g/L to 250 g/L, particularly preferably from 60 g/L to 200 g/L. The density preferably is measured according to DIN ISO 697.

Examples of preferred blowing agents are organic liquids and gases which are in liquid state under the processing conditions.

Preferred organic blowing agents are saturated, aliphatic hydrocarbons, in particular those having from 3 to 8 carbon atoms, more preferred examples are butane or pentane.

Preferred inorganic gases are nitrogen, air, ammonia and carbon dioxide, or a mixture thereof, preferably nitrogen or carbon dioxide, or a mixture thereof.

### EXAMPLES

The examples show that the use of PO3G polyols results in lower heat releases.

### Example 1—Feedstocks

TPU 1: TPU of Shore hardness 85A, based on Velvetol H1000 (poly-propane diol) from Weylchem with a molecular weight of 1000, 1,4-butanediol, methylenediphenyl4,4-diisocyanate (MDI).

TPU 2: TPU of Shore hardness 85A, commercially available as Elastollan 1185A10 from BASF Polyurethanes GmbH, Germany, based on polytetrahydrofuran polyol (PTHF) with a molecular weight of 1000, 1,4-butanediol, and MDI.

Melapur MC 15 ED: Melamine cyanurate (1,3,5-triazine-2,4,6 (1H,3H,5H)-trione, compound with 1,3,5-triazine-2,4,6-triamine (1:1)), CAS #: 37640-57-6, BASF SE, 67056 Ludwigshafen, GERMANY, particle size D99%</=50 μm, D50%<=4.5 μm, water-content % (w/w)<0.2.

Fyrolflex RDP: Resorcinol bis(diphenyl phosphate), CAS #: 125997-21-9, Supresta Netherlands B.V., Office Park De Hoef, Hoefseweg 1, 3821 AE Amersfoort, The Netherlands, Viscosity at 25° C.=700 mPas, Acid number <0.1 mg KOH/g, Water content % (w/w)<0.1.

Exolit OP 1230: Aluminium diethyl phosphinate, CAS #: 225789-38-8, Clariant Produkte (Deutschland) GmbH, Chemiepark Knapsack, 50351 Hürth, Water content % (w/w)<0.2, Average particle size (D50) 20-40 μm.

Melapur 200/70: melamine polyphosphate (nitrogen content 42-44 wt %, phosphorous content 12-14 wt %)), CAS #: 218768-84-4, BASF SE, GERMANY, particle size D99%</=70 μm, average particle diameter D50%<=10 μm, water content % (w/w)<0.3.

Styrolution PS 485N, CAS #: 9003-55-8, Polymer (C₈H₈C₄H₆)ₓ, Styrol-Butadien Copolymer, HIPS, INEOS Styrolution Group GmbH, Mainzer Landstraße 50, DE-60325 Frankfurt, Melt Volume Rate, 200° C./5 kg (ISO 1133): 4 cm³/10 min.

Cloisite 20A: organic modified nano-dispersible layered silicate based on natural Bentonite, BYK-Chemie GmbH, Abelstraße 45, D-46483 Wesel, powder, density 1.80 g/cm³, particle size D50=10 μm, moisture content <2.5%, Lamellar spacing 2.7 nm.

Apyral 40 HS1: aluminum hydroxide with a hydrophobic surface coating based on about 1% of hexadecylsilane, Nabaltec AG, Alustrasse 50-52, D-92421 Schwandorf, Al(OH)₃ content [%]≈99.5, particle size (laser scattering) [μm] D50:1.4, specific surface area (BET) [m²/g]: 3.5.

### 2. Example—Preparation of the Compositions

The following tables 1 to 7 list compositions in which the individual feedstocks are given in weight percentages (weight %). The compounds, also referred to as compositions, were each produced with a twin-screw extruder type ZE 40 A from Berstorff with a processing section length of 35 D divided into 10 zones.
Temperature profile: HZ1 (Elnzug) 175° C. to 185° C.
   HZ2 180° C. to 190° C.
   HZ3 185° C. to 195° C.
   HZ4 185° C. to 195° C.
   HZ5 (nozzle) 180° C. to 190° C.
Screw speed: 100 rpm
Pressure: approx. 10 to 30 bar
Strand cooling: Water bath (10° C.)

TABLE 1

| Example | 1 | 2* | 3 | 4* |
|---|---|---|---|---|
| TPU 1 (PO3G) | 85 | | 70 | |
| TPU 2 (PTHF) | | 85 | | 70 |
| Exolit OP 1230 | 15 | 15 | 30 | 30 |

*Comparative example

TABLE 2

| Example | 5 | 6* | 7 | 8* |
|---|---|---|---|---|
| TPU 1 (PO3G) | 85 | | 70 | |
| TPU 2 (PTHF) | | 85 | | 70 |
| Melapur 200/70 | 15 | 15 | 30 | 30 |

*Comparative example

TABLE 3

| Example | 9 | 10* | 11 | 12* |
|---|---|---|---|---|
| TPU 1 (PO3G) | 85 | | 70 | |
| TPU 2 (PTHF) | | 85 | | 70 |
| Melapur MC 15 ED | 15 | 15 | 30 | 30 |

*Comparative example

TABLE 4

| Example | 13 | 14* | 15 | 16* |
|---|---|---|---|---|
| TPU 1 (PO3G) | 85 | | 70 | |
| TPU 2 (PTHF) | | 85 | | 70 |
| Apyral HS 1 | 15 | 15 | 30 | 30 |

*Comparative example

TABLE 5

| Example | 17 | 18* | 19 | 20* |
|---|---|---|---|---|
| TPU 1 (PO3G) | 85 | | 70 | |
| TPU 2 (PTHF) | | 85 | | 70 |
| Fyroflex RDP | 15 | 15 | 30 | 30 |

*Comparative example

TABLE 6

| Example | 21 | 22* | 23 | 24* | 25 | 26* |
|---|---|---|---|---|---|---|
| TPU 1 (PO3G) | 70.5 | | 64 | | 67.5 | |
| TPU 2 (PTHF) | | 70.5 | | 64 | | 67.5 |
| Exolit OP 1230 | 12.5 | 12.5 | | | | |
| Melapur 200/70 | 6.5 | 6.5 | | | | |
| Melapur MC 15 ED | | | 30 | 30 | 25 | 25 |
| Fyroflex RDP | 4 | 4 | 6 | 6 | 7.5 | 7.5 |
| Styrolution PS | 6.5 | 6.5 | | | | |
| 485N | | | | | | |

*Comparative example

TABLE 7

| Example | 27 | 28* | 29 | 30* | 31 | 32* |
|---|---|---|---|---|---|---|
| TPU 1 (PO3G) | 51.25 | | 51 | | 70 | 70 |
| TPU 2 (PTHF) | | 51.25 | | 51 | | |
| Exolit OP 1230 | | | 10 | 10 | 20 | 20 |
| Melapur 200/70 | | | | | 10 | 10 |
| Melapur MC 15 ED | | | 30 | 30 | | |
| Apyral HS 1 | 34 | 34 | | | | |
| Fyroflex RDP | 9.65 | 9.65 | 9 | 9 | | |
| Cloisite 20 A | 5.1 | 5.1 | | | | |

*Comparative example

### 3. Example—Mechanical Properties

The compounds were extruded into films with a thickness of 1.6 mm using an Arenz type singlescrew extruder with a three-zone screw with mixing section (screw ratio1:3). MFR of the granules used, density according to DIN EN ISO 1133-1:2011, Shore hardness according to DIN ISO 7619-1:2016, tensile strength according to DIN EN ISO 527-2/5A/200:2012, tear resistance according to DIN ISO 34-1, B: 2016 and elongation at break of the corresponding specimens were measured.

### 4. Example—Flame Retardancy

In order to evaluate flame retardancy, a test specimen with a thickness of 5 mm is tested horizontally with radiation of intensity 35 kW/m2 in a cone calorimeter in accordance with ISO 5660 part 1 and part 2 (2002-12). The test specimens for the cone measurements with dimensions 100×100×5 mm were injection molded using an Arburg 520S with screw diameter 30 mm. The key parameters for the cone measurements for the different materials are given in Table 5 and Table 6. The inventive examples show significantly lower THE (Total Heat Release) values in comparison to the comparative examples.

The following tables 8 to 10 show the values of the mechanical properties determined according to the 3rd Example and the flame retardancy determined according to the 4th Example of the compositions as specified in tables 1 to 7.

TABLE 8

| Example | | 1 | 2* | 3 | 4* | 5 | 6* | 7 | 8* | 9 | 10* | 11 | 12* |
|---|---|---|---|---|---|---|---|---|---|---|---|---|---|
| Density | [g/cm³] | 1.16 | 1.15 | 1.2 | 1.2 | 1.21 | 1.2 | 1.28 | 1.27 | 1.2 | 1.2 | 1.3 | 1.2 |
| Shore | [A] | 87 | 87 | 88 | 88 | 86 | 85 | 91 | 90 | 86 | 86 | 91 | 90 |
| Tensile strength | [MPa] | 28 | 26 | 11 | 12 | 33 | 34 | 11 | 15 | 44 | 43 | 22 | 23 |
| Elongation at break | [%] | 670 | 650 | 630 | 640 | 680 | 570 | 550 | 530 | 690 | 570 | 640 | 540 |
| Tear resistance | [kN/m] | 49 | 47 | 42 | 45 | 62 | 65 | 61 | 67 | 62 | 65 | 71 | 67 |
| Abrasion | [mm³] | 92 | 97 | 185 | 172 | 75 | 55 | 116 | 113 | 52 | 31 | 63 | 37 |
| Total heat release | [MJ/m²] | 121 | 129 | 114 | 127 | 140 | 153 | 125 | 130 | 157 | 163 | 145 | 148 |

*Comparative example

TABLE 9

| Example | | 13 | 14* | 15 | 16* | 17 | 18* | 19 | 20* | 21 | 22* | 23 | 24* |
|---|---|---|---|---|---|---|---|---|---|---|---|---|---|
| Density | [g/cm³] | 1.24 | 1.22 | 1.4 | 1.3 | 1.16 | 1.14 | 1.19 | 1.17 | 1.19 | 1.18 | 1.3 | 1.3 |
| Shore | [A] | 87 | 87 | 90 | 91 | 87 | 86 | 91 | 92 | 89 | 87 | 90 | 90 |
| Tensile strength | [MPa] | 36 | 34 | 22 | 21 | 48 | 46 | 37 | 35 | 24 | 27 | 24 | 25 |
| Elongation at break | [%] | 610 | 630 | 640 | 650 | 660 | 630 | 690 | 680 | 610 | 590 | 610 | 550 |
| Tear resistance | [kN/m] | 56 | 57 | 55 | 54 | 39 | 38 | 32 | 31 | 52 | 48 | 61 | 60 |
| Abrasion | [mm³] | 102 | 110 | 202 | 210 | 59 | 65 | 88 | 95 | 98 | 97 | 48 | 35 |
| Total heat release | [MJ/m²] | 158 | 167 | 140 | 147 | 130 | 160 | 115 | 152 | 117 | 131 | 125 | 135 |

*Comparative example

TABLE 10

| Example | | 25 | 26* | 27 | 28* | 29 | 30* | 31 | 32* |
|---|---|---|---|---|---|---|---|---|---|
| Density | [g/cm³] | 1.25 | 1.24 | 1.44 | 1.42 | 1.32 | 1.25 | 1.25 | 1.20 |
| Shore | [A] | 87 | 89 | 86 | 86 | 92 | 91 | 90 | 92 |
| Tensile strength | [MPa] | 26 | 29 | 17 | 20 | 11 | 17 | 15 | 32 |
| Elongation at break | [%] | 680 | 600 | 690 | 580 | 620 | 550 | 700 | 500 |
| Tear resistance | [kN/m] | 58 | 60 | 36 | 55 | 60 | 55 | 55 | 60 |
| Abrasion | [mm³] | 45 | 35 | n.b. | — | 91 | 80 | 150 | 75 |
| Total heat release | [MJ/m²] | 135 | 150 | 114 | 128 | 104 | 125 | 105 | 135 |

1. A composition, comprising:
a thermoplastic polyurethane, wherein the thermoplastic polyurethane is a reaction product of at least building components
a) diisocyanate,
b) poly-propane diol, and
c) chain extender,
and the composition further comprises a flame retardant, wherein the flame retardant comprises phosphorus.

2. The composition according to claim 1, wherein the poly-propanediol is 1,3-poly-propanediol.

3. The composition according to claim 1, wherein a total heat release (THR) measured according to ISO 5660 part 1 and part 2 (2002-12) is less than 160 MJ/m² measured in a cone calorimeter on 5 mm plates with 35 kW.

4. The composition according to claim 1, wherein a tensile strength measured according to DIN 53504:2017-03 is greater than 10 MPa.

5. The composition according to claim 1, wherein a Shore A hardness of the composition is between 75 and 100.

6. The composition according to claim 1, wherein the flame retardant is a derivative of phosphorus acid, phosphonic acid, phosphinic acid, or a mixture thereof.

7. The composition according to claim 1, wherein the flame retardant comprises Resorcinol bis(diphenyl phosphate) (RDP).

8. The composition according claim 1, wherein the flame retardant comprises a metal hydroxide, a metal oxide hydrate, or mixtures thereof.

9. The composition according to claim 8, wherein the metal is aluminium, magnesium, or mixtures thereof.

10. The composition according to claim 1, wherein the flame retardant comprises aluminium hydroxide, aluminium oxide hydrate, or mixtures thereof.

11. The composition according to claim 8, wherein the metal hydroxide or the metal oxide hydrate or both are at least partly covered with a coating.

12. The composition according to claim 1, wherein the flame retardant comprises a derivative of phosphoric acid.

13. The composition according to claim 12, wherein the flame retardant further comprises melamine cyanurate.

14. The composition according to claim 13, wherein the flame retardant further comprises a derivative of a phosphinic acid.

15. The composition according to claim 1, wherein the flame retardant comprises melamine polyphosphate.

16. The composition according to claim 15, wherein the flame retardant further comprises a derivative of a phosphinic acid.

17. The composition according to claim 16, wherein the flame retardant comprises a metal salt of the derivative of the phosphinic acid, wherein the metal salt comprises at least one metal selected from the group consisting of aluminium, calcium, zinc, and mixtures thereof.

18. The composition according to claim 1, wherein the flame retardant comprises aluminium diethyl phosphinate.

19. A cable, comprising:
the composition according to claim 1.
